(19) United States
(12) Patent Application Publication
(10) Pub. No.: US 2010/0255235 A1
(43) Pub. Date: Oct. 7, 2010

(54) METHOD FOR PRODUCING A FIBER COMPOSITE HOLLOW BODY HAVING A FIBER ORIENTATION OPTIMIZED FOR FORCE FLOW AND TENSION

(75) Inventors: Karl-Heinz Ilzhoefer, Kirchheim (DE); Asmir Salkic, Ulm (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/744,348

(22) PCT Filed: Sep. 9, 2008
(86) PCT No.: PCT/EP08/07362

§ 371 Date: May 24, 2010

(30) Foreign Application Priority Data
Nov. 28, 2007 (DE) 10 2007 057 198.6

(51) Int. Cl. B29C 70/08; B29C 70/30; B32B 7/08

(52) U.S. Cl. 428/36.3; 156/243; 156/91

(57) ABSTRACT

A method for producing a fiber composite hollow body, particularly a hollow fiber composite component for a motor vehicle. The hollow body is produced by a) applying and fixing continuous reinforcement fibers to a form corresponding to the later shape of the hollow body, wherein the arrangement of the fiber material with regard to the fiber composite hollow body takes place so as to optimize force flow and tension along a pre-defined load path, b) impregnating the reinforcement fibers with a curable resin, c) curing the applied resin to form a fiber composite component, and d) dissolving, melting, or removing the lost form to form the fiber composite hollow body. The lost form has a complex geometry. The fibers, which may be impregnated, are placed tightly onto the surface of the lost form, completely forming the surface contour.

The invention relates to methods for producing a complex fiber composite hollow body, especially a hollow FVK component for a motor vehicle, wherein the arrangement of the fiber material with regard to the fiber composite hollow body to be produced takes place in a manner optimized for force flow and tension.

The established production methods of rotation-symmetric fiber-reinforced composite bodies, or fiber-reinforced plastics (FVK) include the winding method. For tubes, fiber strands, bundles or tapes are thereby for example impregnated with a reaction resin and are wound onto a rotating cylindrical mold. The adhesion of the fibers takes place via the tensile strength of the applied strands. After the curing of the resin, the mold is removed from the finished tube.

This is hardly possible with bodies having a more complex geometry, for example with undercuts or convex or concave transfers. In these cases, it is attempted to wind the fibers onto lost forms, which consist of salts, waxes or other materials, which are removed or melted after the finishing of the winding structure and curing of the resin. The fibers also have to adhere to the mold by means of their tensile strength, whereby considerable geometric restrictions result with regard to the fiber geometry. With complex shapes, the pressure force which the fiber material applies to the lost core can also take on very considerable sizes, which complicates and increases the cost of the arrangement of the core and the production process. These methods are for example known from DE 69810487 T2.

A further known method for the production of fiber-reinforced composite bodies is the so-called pressure bag method, which can be used during the mass production of hollow reinforced plastic parts. The reinforcement material is inserted into a two-piece moldy in the shape of cut-out fabric pieces, netting, SMC or pre-formed reinforcements. A pressure bag is introduced and the mold is closed. Fluid resin is then injected into the mold in order to impregnate the reinforcement material. The pressure bag is then inflated, and is pressed against the inner side of the mold in this manner. The resin is cured in this state. The pressure bag is emptied during the ejection and is removed again. A winding method with a pressure bag is for example disclosed in U.S. Pat. No. 3,610,563. These methods have the disadvantage that a targeted load path-optimized fiber orientation cannot be adjusted.

The known methods have the disadvantage that the reinforcement fibers can only be oriented in a load path-optimized manner in a very restricted manner. Surface contours, especially undercuts or comparatively small recesses can hardly be reproduced. As the fibers have to be applied with a tensile strength with the winding technique, undercuts and recesses of the mold core are spanned and can thus not be reproduced. These are not longer close to the surface and cannot reproduce the surface contour in an exact manner even where the fibers lie thereon with low or even no tensile strength. The similar is valid for the pressure bag technique.

With the winding technique, the geometric orientation of the reinforcement fibers is also highly restricted, as only those orientations can be chosen which enable a tensile strength of the fibers, or a pressure tension on the core. The targeted oriented deposit of fibers in the mold is only possible in a difficult manner with the pressure bag technique. The pressing by means of the pressure bag can change the fiber orientation in a considerable manner.

It is therefore the object of the invention to provide a production method for hollow fiber-reinforced composite components, or FVK components (fiber-reinforced plastic components), which permits the component contour even with complex geometries such as undercuts or convex or concave transfers, and which permits a load path-optimized orientation of the fibers.

The object is solved according to the invention with a method for producing a fiber composite hollow body, particularly a hollow fiber composite component for a motor vehicle, comprising the following method steps:

a) applying and fixing continuous reinforcement fibers to a lost form corresponding to the later shape of the hollow body, wherein the arrangement of the fiber material with regard to the fiber composite hollow body takes place in a manner optimized for force flow and tension,

b) impregnating the reinforcement fibers with a curable resin,

c) curing the applied resin to form a fiber composite component, and

d) dissolving, melting, or removing the lost form to form the fiber composite hollow body, wherein a lost form is used that has a complex geometry and the fibers are placed tightly onto the surface of the lost form, with the characteristics of claim 1.

A further solution is given by a method with the defining method steps:

I) applying resin to continuous reinforcement fibers or fiber bundles while forming resin-coated continuous reinforcement fibers,

II) applying the resin-coated continuous reinforcement fibers to a lost form corresponding to the later hollow space, wherein the arrangement of the fiber material with regard to the fiber composite hollow body to be produced takes place in a manner optimized for force-flow and tension,

III) curing the applied fiber material while forming a fiber composite component and

IV) dissolving, melting or removing the lost form while forming the fiber composite hollow body,

wherein the applying of the fiber material on the lost form takes place by a depositing, weaving, braiding, stitching and/or sewing, with the characteristics of claim 3.

It is thus provided in a first arrangement according to the invention to apply the reinforcement fibers onto the lost form in a load path-optimized manner, or with regard to the fiber composite hollow body to be produced , optimized for force flow and tension. It is thereby of essential importance to apply the fibers with a complete reproduction of the surface contour and tightly to the surface of the lost form. When applying the reinforcement fibers, these are fixed on the lost core by suitable means. By means of the fixing, the necessary pressure of the fibers on the surface of the core is achieved, so that these lie tightly on the surface and reproduce the contour. The geometric orientation of the fibers, in particular fiber bundles or strands, is thereby no longer subject to the restrictions of the winding method or the pressing method.

In a further arrangement according to the invention, continuous reinforcement fibers which are already impregnated with resin are used. It is thereby of essential importance that the application of the fiber material on the lost form takes place by depositing, weaving, braiding, stitching and/or sewing. It is ensured by this method that the fibers lie tightly on the surface, reproduce the surface of the lost form in an exact manner and that undercuts or recesses of the lost form are also reproduced in an exact manner. For the impregnation of the continuous reinforcement fibers, in addition to fluid resins, solid resin powders are also suitable, which are added to the fibers prior to the fixing. The use of solid resin in the shape of fibers, for example in the form of a so-called commingled yarn is a suitable version.

The further method steps and their special arrangement forms can analogously be used for impregnated or also for reinforcement fibers which are not yet impregnated.

The continuous reinforcement fibers can consist of glass fibers, carbon fibers, ceramic fibers, metal fibers, natural fibers or a mixture of at least two of these fiber materials. Carbon fibers, aramide fibers and glass fibers are particularly preferred. In a further arrangement of the invention, thermoplastic plastic fibers are also contained with the reinforcement fibers.

The application of the reinforcement fibers can take place by means of fiber-technological plants usual in textile processing, as for example weaving, braiding, or sewing automats. The term “fibers” is thereby meant to be the single filament and also fiber bundles, rovings or yarns of continuous fiber reinforcement fibers.

The fixing of the fibers can thereby take place in different manners, especially by the fixing of the applied continuous reinforcement fibers by stitching, sewing, adhering or by mechanical fixing means. The different methods of the fixing can be combined in a suitable manner. This is also possible in a very simple manner according to the invention, as the entire surface of the lost form to be processed is on the exterior, or an obstruction of the access by press molding or the like does not exist.

The fixing is carried out in a preferred arrangement in such a manner that the reinforcement fibers are sewn or stitched onto the base or the surface of the core. For this, the lost core preferably has a textile surface, which offers a good adhesive base for the sewing thread or the stitching. This can for example be a material covering of the lost core, which itself remains in the finished composite component after the removal of the lost core. Plastic cores, in particular also polymer foam cores are also suitable for the sewing or stitching.

The depositing of the fibers or also the contour-close weaving on the surface of the lost core can preferably be combined with the sewing or stitching. Needling is also suitable for the fixing.

Further possibilities for fixing the fibers to the surface are mechanical fixing means. This can for example be clamps or adhesive tapes.

The fixing can further take place via discrete adhesive points or adhesive surfaces. It is thereby advantageous if the adhesives are applied to the lost form prior to the deposit of the fibers. In a preferred embodiment, the surface of the lost form is provided with adhesive resin at least in the fiber deposit regions. Suitable adhesives are also acrylate adhesives or natural rubber adhesives.

The lost form can thereby for example be coated with a reaction resin which is especially already adhesive, which is only cured by a starter applied to the fibers. The fiber can for example be provided with a thin layer of fluid starter immediately prior to the application, such that the reaction resin cures quickly subsequent to the application of the fibers. Cold-curing reaction resins are especially suitable with this procedure.

A further convenient version provides that the fixing of the applied continuous reinforcement fibers takes place by the adhesive action of a resin which is present on the continuous fibers. For this, the resin or the adhesive is preferably applied to the lost form of the fibers directly prior to the application onto the lost form. This can for example take place by means of an impregnating bath or by means of an impregnating nozzle at the thread head of the textile machine.

A further preferred arrangement of the invention provides retention structures on the surface of the lost form for fixing the reinforcement fibers. Typical retention structures are microscopic hooks, loops or barbed hooks similar to a Velcro fastener. The structures can also represent a separate surface coating of the lost form, for example a Velcro fastener fabric fixed to the surface. In the latter case, the fabric remains at the composite component after removing the lost form. In a further preferred arrangement, retention structures are used in combination with adhesives.

After the fixing of the reinforcement fibers, or their fixation, the matrix material has to be brought into the fibers in the form of a curable resin. This impregnation takes place by impregnation of the entire structure of fibers and lost core. Known methods such as RTM (resin transfer molding) or vacuum injection can be used here. With these methods, the curing of the matrix resin usually takes place immediately after the impregnation while forming a fiber composite component.

Most of the established thermal, cold-curing or UV curing resin systems are suitable as curable resins. Preferred resin systems comprise polyesters, polyurethanes and/or polyamides.

The use of an autoclave is particularly suitable for curing thermally curing resins. The pressure acting during the curing leads to composite components which have few pores and faults. By the additional use of outer cores, particularly exact geometries and an improved surface quality can be generated here. Hereby, no further tools of steel or aluminum are usually necessary. Prototypes and low quantities can thus also be manufactured in an economical manner.

The curing according to method step c) can however also take place in a press mold by pressing, possibly with heating. It is thereby typically sufficient if the press form only reproduces the approximate contour of the composite component. The reproduction of the fine contour, or the undercuts and recesses are achieved by the tight deposit and fixing of the fibers according to the invention.

The lost form, especially formed by a shape-giving core, is removed after curing (method step d). Forms or lost cores are thereby used preferably, which can be dissolved or melted. Polymer foam cores are especially preferred amongst the plastic cores. Plastic materials or also wax cores are suitable amongst the meltable cores. Wax or plastic-bound sand cores can also be used in the same manner. Plastic cores usually offer a good adhesive base for adhesives or for adhering special retention means.

The cores thereby do not have to be massive, but can also have hollow spaces in the same manner. The production can be simplified hereby and the material use can be reduced.

Assembled cores which can again be disassembled for removing in a suitable manner are also suitable.

The method step for applying and fixing the continuous reinforcement fibers is also suitable in an excellent manner for the simultaneous integrating of functional parts into the fiber structure. The functional parts can for example be sewn into the fibers or stitched thereon.

In a preferred version, the functional parts are arranged at the surface of the lost form, so that the lost form acts as a support structure. The parts can for example project partially into the lost core for fixation. The functional parts are preferably chosen of fiber prepregs, metal parts and/or plastic parts.

If fiber prepregs are used as functional parts, the very cost-efficient possibility results here to realize limited regions with massive material collection or component thickness. The curing of the prepregs conveniently takes place in the method step c).

Sleeves for metallic fixing elements such as screws and welding bridges or hinges are important as mechanical functional parts.

These fiber composite components are preferably used in motor vehicle construction, especially during the production of floor or wall parts in the motor vehicle cell or in the interior of automobiles.

The fiber composite body can also be used as a green body for the production of CFC (carbon fiber reinforced carbon), or C/C composite bodies, or also as CMC composite body (ceramic matrix composites). For this, the FVK components are carbonized in a known manner and infiltrated and redensified if necessary.

1. A method for producing a fiber composite hollow body with a load path, comprising the following method steps:
a) applying and fixing continuous reinforcement fibers to a lost form corresponding to the later shape of the hollow body, wherein the arrangement of the fiber material with regard to the fiber composite hollow body to be produced takes place in a manner so as to optimize force flow and tension along the load path of the hollow body,
b) impregnating the reinforcement fibers with a curable resin,
c) curing the applied resin while forming a fiber composite component, and
d) dissolving, melting, or removing the lost form while forming the fiber composite hollow body,
wherein the lost form has a complex geometry and the fibers are placed tightly onto the surface of the lost form, completely forming the surface contour.

2. The method according to claim 1, wherein the applying of the fiber material takes place by depositing, weaving, braiding, stitching or sewing onto the lost form.

3. A method for producing a fiber composite hollow body with a load path, comprising the following method steps:
I) applying resin to continuous reinforcement fibers or fiber bundles while forming resin-coated continuous reinforcement fibers,
II) applying the resin-coated continuous reinforcement fibers onto a lost form corresponding to the later hollow space, wherein the arrangement of the fiber material with regard to the fiber composite hollow body to be produced takes place in a manner optimized for force flow and tension along the load path,
III) curing the applied fiber material while forming composite component, and
IV) dissolving, melting, or removing the lost form while forming the fiber composite hollow body,
wherein the applying of the fiber material takes place by depositing, weaving, braiding, stitching and/or by sewing onto the lost form.

4. The method according to claim 1, wherein the fixing of the applied continuous reinforcement fibers takes place by stitching, sewing, adhering or by mechanical fixing means.

5. The method according to claim 3, wherein the fixing of the applied continuous reinforcement fibers takes place by the adhesive action of a resin which is present on the continuous fibers.

6. The method according to claim 1, wherein the surface of the lost form is formed with adhesive resin at least in the fiber deposit regions.

7. The method according to claim 1, wherein the surface of the lost form is provided with a retention structure comprising barbed hooks at least in the fiber deposit regions.

8. The method according to claim 1, wherein the surface of the lost form is formed by a textile material at least in the fiber deposit regions.

9. The method according to claim 1, wherein the fixing of the continuous reinforcement fibers to the lost form takes place by means of mechanical fixing means.

10. The method according to claim 1, wherein a lost form with undercuts or surface recesses is used.

11. The method according to claim 1, wherein the resin is chosen from the group of the thermal, cold-curing or UV curing polyesters, polyurethanes and/or polyamides.

12. The method according to claim 1, wherein the curing according to the method step c) comprises a pressing and/or heating.

13. The method according to claim 1, wherein the lost form is constructed of meltable and/or soluble plastics or foamed plastics.

14. The method according to claim 1, wherein the lost form is constructed of wax.

15. The method according to claim 1, wherein the continuous reinforcement fibers are glass fibers, carbon fibers, ceramic fibers, metal fibers, natural fibers or a mixture of at least two of these fiber materials or of a combination of these fibers with thermoplastic plastic fibers.

16. The method according to claim 1, wherein during the application of the continuous reinforcement fibers, functional parts are bound into the fiber structure.

17. The method according to claim 1, wherein the functional parts are arranged at the surface of the lost form, wherein the lost form acts as a support structure.

18. The method according to claim 1, wherein the functional parts are chosen from fiber prepregs, metal parts and/or plastic parts.

19. A hollow fiber composite component for a motor vehicle produced according to claim 1.
